(19) United States
(12) Patent Application Publication
(10) Pub. No.: US 2023/0288222 A1
(43) Pub. Date: Sep. 14, 2023

(54) SOCIAL NETWORK MAPS WITH REGIONAL STORIES

(71) Applicant: Meta Platforms, Inc., Menlo Park, CA (US)

(72) Inventors: William Samuel Bailey, Shibuya (JP); Joshua Barton Dickens, Shibuya (JP); Jessica S. Liang, Bedford, NY (US); Key K. Shin, Menlo Park, CA (US)

(21) Appl. No.: 17/691,072

(22) Filed: Mar. 9, 2022

(51) Int. Cl. G01C 21/00; G06T 15/10; G01C 21/34; G01C 21/36

(52) U.S. Cl. CPC G01C 21/3811; G01C 21/3863; G06T 15/10; G01C 21/3476; G01C 21/3484; G01C 21/3682; G06Q 50/01

(57) ABSTRACT

A social networking system may generate a region of an interactive map and determine a zoom level at which the interactive map is being presented. The social networking system may then determine a first defined geographic region based at least in part on the region being displayed and the zoom level at which the interactive map is being displayed. A quantity of content items that exists that are associated with the first define geographic region can be determined by the system. The social networking system may then present, based at least in part on the quantity, a visual representation on the interactive map of one or more content items associated with at least one of the first defined geographic region or a second defined geographic region that encompasses the first defined geographic region.

### BACKGROUND

Social networking systems allow users to connect and interact with one another by sharing events, content such as photos and videos, and interests. Users are continually searching for ways to find new locations and experiences and share these experiences and locations with others. Therefore, social networking systems continue to provide users with increasing options for finding new locations and experiences that allow users to connect with one another.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates a schematic block diagram illustrating example techniques for presenting an interactive map with visual representations of content items associated with locations and/or regions of the interactive map.

FIGS. 2A-2B illustrate example user interfaces usable to provide multiple different types of feedback associated with a location of the interactive map.

FIG. 3 illustrates an example user interface usable to display a story associated with a location of the interactive map.

FIGS. 4A-4C illustrate example user interfaces usable to display an interactive map that displays a geographic region.

FIGS. 5A-5C illustrate example user interfaces usable to display an interactive map that displays a geographic region.

FIGS. 6A-6C illustrate example user interfaces usable to display a multi-author story associated with a geographic region.

FIG. 7 is a flowchart illustrating an example method to provide multiple different types of feedback associated with a location on an interactive map.

FIG. 8 is a flowchart illustrating an example method to display content items associated with a geographic region on an interactive map.

FIG. 9 is a schematic illustration of an example system and device usable to implement the techniques described herein.

### DETAILED DESCRIPTION

While conventional location service applications and devices can provide users with maps of places around the users, directions to specific addresses, and the like, they are not without limitations. In some cases, a user may know a type of location that the user wants to visit (e.g., a coffee shop), but may not know what specific location they want to visit. As discussed above, social networking systems continue to develop fun and unique ways for users to connect with each other and share experiences. By sharing photos and videos with followers on social media, users may provide an insight to places they have seen, visited, and experienced to encourage others to visit (or discourage them from visiting). Thus, the described techniques provide functionality beyond what is provided in conventional map applications by showing users feed posts, stories, and other content associated with places that the users are more likely to trust. For example, the described techniques provide an interactive map that is populated with content (e.g., feed posts, stories, etc.) at tagged locations and may be shared by accounts that a user follows on the social networking system. Additionally, the user may provide feedback associated the location, such as saving the location to a stored collection, checking-in at the location indicating that the user has been to the location, and/or recommending the location. Thusly, other users may be encouraged to go (or discouraged from going) to those locations based on the feedback provided by the user account and/or other user accounts.

This application describes techniques for providing social network maps via a social networking system and/or service (herein referred to as a “social networking system”). As described in more detail below, a map provided by the social networking system provides an insight to area attractions based on a user's social network and/or a request to view specific items on the map, and encourages users to share their favorite places with one another.

For instance, in one example, a social networking system may operate a service that corresponds to a dedicated application installed on a user device. The social networking system may enable users to share content via the application installed on the user device. In some cases, the shared content may be accessed (e.g., viewed) by devices associated with other users that also have the application installed on their respective devices. Alternatively or additionally, the social networking system may enable users to share content, and/or access (e.g., view or stream) content shared by other user accounts, via a web-based application accessed via a web browser. The social networking system may store account information associated with each user and the respective device on which the application is installed.

In some examples, the social networking system may receive, from a first user account associated with the social networking system, a content item and/or a particular type of feedback associated with a location. By way of example and not limitation, the content item may include a feed post, reel, or a story. The particular type of feedback may include saving the location to a collection, checking-in at the location indicating that the first user has been to the location, and/or recommending the location. In some examples, the social networking system may select a content item associated with a location previously shared by a second user account associated with the social networking system. In some examples, the content item and/or the particular type of feedback may be persistent (e.g., non-ephemeral) and, once shared by the second user account, populates feeds of user accounts that follow the second user account on the social networking system. In some examples, the content item and/or the particular type of feedback may be ephemeral and may be stored, displayed, and/or associated with the location for a finite period of time, after which the content item may be removed and/or dissociated from the location. The social networking system may generate an interactive map, that includes the location, with a visual representation of the content item associated with the location. In some examples, the social networking system may provide the interactive map with a control usable to provide multiple different types of feedback associated with the location to the first user account. By way of example and not limitation, the multiple different types of feedback may include a first type of feedback (e.g., save, store, bookmark, etc.), a second type of feedback (e.g., been there, check in, etc.), and/or a third type of feedback (e.g., like, love, recommend, etc.). After the user selects a particular type of feedback from among the multiple different types of feedback, the social networking system then performs an action that is associated with the selected particular type of feedback. In some cases, the interactive map allows the user to view the location of a device associated with the user account relative to the location associated with the content item, select the content item to view additional details associated with the location, scroll on the map, zoom in, and zoom out, to name a few examples.

In some examples, the social networking system may generate and display a region of the interactive map and determine a zoom level at which the interactive map is displayed. The displayed interactive map may include a first defined geographic region that is based on at least in part on a zoom level at which the interactive map is being displayed. In some cases, the displayed first defined geographic region may correspond to a state, prefecture, county, city, or neighborhood. Within the displayed first geographic region, the social networking system may determine a quantity of content items associated with the first defined geographic region. The social networking system may then present to the user a visual representation on the interactive map of the content items. In some examples, the content items may additionally or alternatively be associated with a second defined geographic region that encompasses the first defined geographic region. In some examples, the social networking system may determine if the quantity of content items associated with the first defined geographic area is below a threshold number. In this case, the social networking system may present one or more content items associated with the second defined geographic region when the quantity of content items is below the threshold. In this way, the system may provide at least the threshold quantity of content to a user even if the quantity of content items associated with the first defined geographic region is sparse (e.g., below the threshold). In some examples, the social networking system may determine whether to present visual representations associated with first defined geographic region or the second defined geographic region. Furthermore, the social networking system may display a list of content items associated with either the first defined geographic region or the second defined geographic region.

In some examples, the social networking system may receive an input from the user that moves a defined geographic region displayed on the interactive map. Upon receiving the input, the social networking system may update the defined geographic region displayed on the interactive map and present an updated list of content items that are associated with the updated defined geographic region.

In some examples, the social networking system may display guides that include the content items associated with locations that are also associated with the first defined geographic region and/or the second defined geographic region. The guides may function to display references associated with the locations associated with the defined geographic region displayed on the interactive map and/or locations within a threshold distance (e.g. 1 mile, 5 miles, 10 miles, etc.) of the defined geographic region displayed on the interactive map. The references may include topics such as services nearby (e.g., a restaurant, a gas station, a nail salon, a food truck, etc.), attractions nearby (e.g., a park, a museum, a theme park, a beach, etc.), or items nearby (e.g., coffee, donuts, ice cream, Thai food, etc.), to name a few examples. The guides may also include user reviews and/or comments associated with the location and/or the content items included in the guides.

In some examples, the visual representations displayed on the interactive map may include a multi-author story. The multi-author story may include a first content item that was authored by a first user account and a second content item authored by a second user account. The first content item and the second content item may be associated with the defined geographic region displayed on the interactive map. In some cases, the multi-author story may be generated when an item of content provided by a user is tagged to a defined geographic region by the user.

In some examples, the interactive map may include a visual representation associated with a first content item that is associated with a location in the defined geographic region displayed on the interactive map. The visual representation may also be associated with at least a second content item associated with the location. The social networking system may then display a list outlining details regarding the location and at least one content item associated with the location. A visual indicator (e.g., a pill shaped icon, a play icon, an icon etc.) may be displayed on the list that is configured to access (e.g., view or stream the content items) at least the second content item.

In some examples, the social networking system may perform actions, such as storing the location to a collection of saved locations associated with the user, providing a visual indication that the user has been to the location, and/or providing a visual indication that the user recommends the location. In some cases, the social networking system may perform an action that includes displaying a visual representation of the selected particular type of feedback on the interactive map.

In some examples, the social networking system may receive from a user account, content items associated with the location. The social networking system may then generate a multi-author story associated with the location. The multi-author story may include content items provided by the users. In some examples, the content item may be a first content item associated with the multi-author story, and the interactive map may include a thumbnail of the content item and/or the multi-author story. For instance, the interactive map may display a small image of a visual representation associated with the multi-author story, in the thumbnail. In some examples, a selection of the thumbnail of the content item displays the first content item and a second content item associated with the multi-author story. Thus, once the user selects the thumbnail on the map, the user may view additional content items associated with the multi-author story.

In some examples, the social networking system may determine a location of a device associated with the first user account. In some cases, the social networking system may determine that the location associated with the content item is within a threshold distance (e.g. 1 mile, 5 miles, 10 miles, etc.) of the location of the device, where the interactive map may be limited to include visual representations of content items within the threshold distance. In this way, the interactive map includes content items previously shared by user accounts that the user follows within a threshold distance of the user and associated with a desired topic, where the threshold distance may correspond to a distance that the user may travel to in a certain amount of time (e.g., a 10-minute walk, a 20-minute drive, etc.).

In some examples, the first content item and the second content item are displayed based on a popularity of the individual content items relative to one another and/or a recency that the individual content items are shared. Popularity, for example, may be based on a number of “likes” and/or comments the content item has, where the multiple content items may be displayed in order of descending number of “likes” and/or comments. Additionally or alternatively, recency may be based on a time that the content item was shared, where the most recent content items may be displayed first.

In some examples, the social networking system may determine if a user is physically within a threshold distance of the location. The system may generate an automated response upon receiving the content item from the user if the user is within a threshold distance from the location. The automated response may prompt the user to select a particular type of feedback. In some examples, the automated response may prompt the user to recommend the location.

In some examples, the social networking system may determine that the first user account is a “follower” of the second user account on the social networking system. In some cases, the social networking system may select the content item to display on the interactive map based in part on the first user account following the second user account. In this way, the social networking system may prioritize content items to display on the interactive map that the first user is interested in, based on accounts that the first user chooses to follow.

In some examples, the social networking system determines that a first user account associated with a social networking system follows a second user account on the social networking system. The social networking system selects content item associated with a multi-author story previously shared by the second user account. The social networking system may further generate an interactive map comprising a visual representation of the content item, and provide the interactive map comprising the visual representation of the content item to the first user account. In this way, the social networking system may populate the interactive map with visual representations of content items that the first user is interested in, based on accounts that the first user chooses to follow, even without a search for a particular location.

In some examples, the content item is one of multiple content items. The social networking system may further generate a list of the multiple content items. In some cases, the social networking system may provide the list of the multiple content items to the first user. The list may include information about the locations included in the feed posts in a way that may be easier for the user to consume than in the interactive map view.

In some examples, the social networking system may further determine a location of a device associated with the first user account. The social networking system may determine that the content item associated with the location is within a threshold distance of the location of the device, where interactive map may be limited to include posts within the threshold distance. In this way, the interactive map includes feed posts within a threshold distance of the user, where the threshold distance may correspond to a distance that the user may travel to in a certain amount of time (e.g., a 10-minute walk, a 20-minute drive, etc.). Thus, the social networking system may provide content items that the user may travel to within a reasonable amount of time.

In some examples, the social networking system may present the interactive map to a third user account that follows the second user account. The interactive map may include an indication that the second user account recommends the location, a visual indication of the content item shared by the second user account, and/or a visual indication of the multi-author story associated with the content item shared by the second user account.

In some examples, the feed post may be one of multiple feed posts, and the list of feed posts provided to the user may include at least one of hours of operation of a business associated with the location, a category of service provided, an open or closed status, and/or an average price of products or services offered by respective locations tagged in the multiple feed posts.

In this way, the social networking system may populate a map with places that a user may want to visit based in part on locations shared by user accounts that the user follows on the social networking system. By displaying these locations, the techniques described in this application provide improvements to current techniques by providing users the opportunity to decide where to visit based on the experiences of others they may know and trust. Additionally, the techniques described herein improve performances of one or more computing devices by reducing the amount of content sent over a network. For instance, by selecting a feed post associated with a multi-author story and providing a user an interactive map comprising the feed post, the social networking system can reduce the amount of content transferred between the social networking system and a location service system. In this way, the social networking system may simplify the number of inputs necessary to provide the multiple different types of feedback since the social networking system presents the user with multiple distinct options (e.g., Save, Been There, and Love in this example). In some cases, the system may provide at least the threshold quantity of content to a user even if the quantity of content items associated with the defined geographic region displayed on the interactive map is sparse (e.g., below the threshold).

These and other aspects are described further below with reference to the accompanying drawings. The drawings are merely example implementations and should not be construed to limit the scope of the claims. For example, while examples are illustrated in the context of a user interface for a mobile device, the techniques may be implemented using any computing device and the user interface may be adapted to the size, shape, and configuration of the particular computing device.

### Example System Architecture

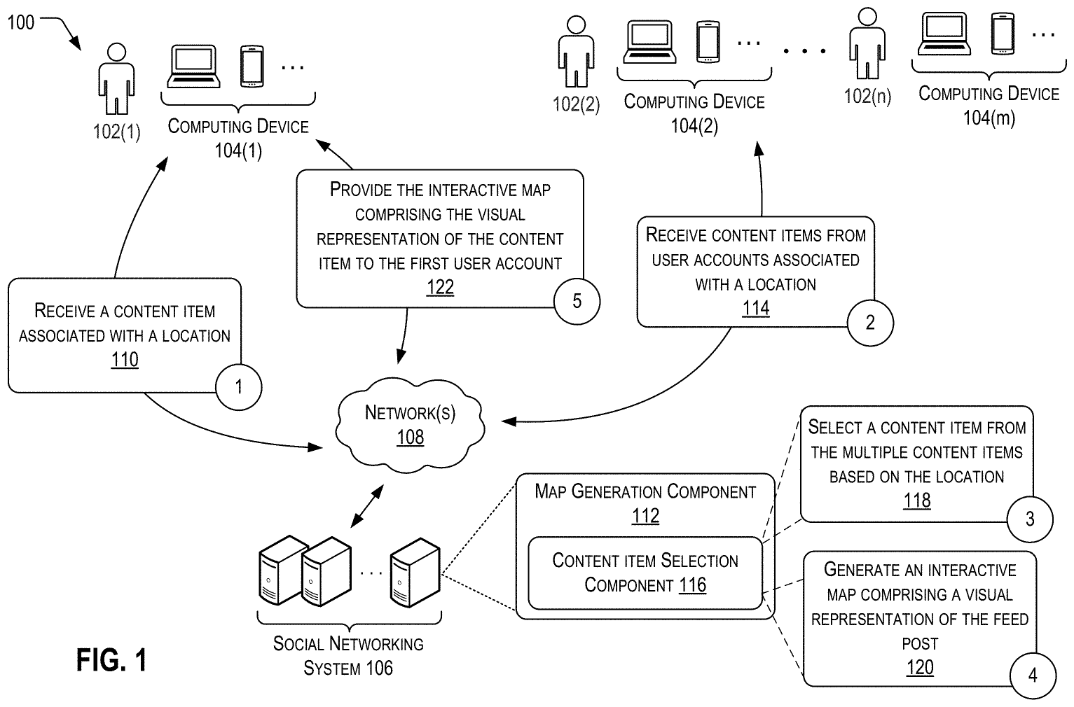

FIG. 1 is a schematic view of an example computing system 100 usable to implement example techniques described herein to facilitate social network collections on an application via the system 100. In some examples, the system 100 may include users 102(1), 102(2), . . . 102(n) (collectively “users 102”) to interact using computing devices 104(1), 104(2), . . . 104(m) (collectively “computing devices 104”) with a social networking system 106 via a network 108. In this example, n and m are non-zero integers greater than 1.

Each of the computing devices 104 includes one or more processors and memory storing computer executable instructions to implement the functionality discussed herein attributable to the various computing devices. In some examples, the computing devices 104 may include desktop computers, laptop computers, tablet computers, mobile devices (e.g., smart phones or other cellular or mobile phones, mobile gaming devices, portable media devices, etc.), or other suitable computing devices. The computing devices 104 may execute one or more client applications, such as a web browser (e.g., Microsoft Windows Internet Explorer, Mozilla Firefox, Apple Safari, Google Chrome, Opera, etc.) or a native or special-purpose client application (e.g., social media applications, messaging applications, email applications, games, etc.), to access and view content over the network 108.

The network 108 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the computing devices 104 may access the social networking system 106 and/or communicate with one another.

The social networking system 106 may include one or more servers or other computing devices, any or all of which may include one or more processors and memory storing computer executable instructions to implement the functionality discussed herein attributable to the social networking system or digital platform. The social networking system 106 may enable its users 102 (such as persons or organizations) to interact with the social networking system 106 and with each other via the computing devices 104. The social networking system 106 may, with input from a user, create and store in the social networking system 106 a user account associated with the user. The user account may include demographic information, communication-channel information, financial information and information on personal interests of the user. The social networking system 106 may also, with input from a user, create and store a record of relationships of the user with other users of the social networking system, as well as provide services (e.g., posts, comments, photo-sharing, messaging, tagging, mentioning of other users or entities, games, etc.) to facilitate social interaction between or among the users 102.

The social networking system 106 may be configured to generate a map comprising visual representations of content items shared by the users 102 via the computing devices 104 on the social networking system 106.

For example, at operation 110 (indicated by “1”), a map generation component 112 of the social networking system 106 may receive a content item associated with a location. In some examples, the map generation component 112 may be part of a social network service (e.g., Facebook®, Instagram®, etc.), although other examples of services are also considered. In some examples, the content items may comprise feed post or a story that are associated with the location. In some cases, the content item may be received from a first user 102(1) associated with the computing device 104(1). The content item may include a feed post or a story. For example, the first user 102(1) may use a digital keyboard and a digital camera of the computing device 104(1) to enter the content item.

At operation 114 (indicated by “2”), content item selection component 116 of the map generation component 112 receives one or more content items from user account(s) associated with a location. For instance, a second user 102(2) may share content item via the social networking system 106. The social networking system 106 may cause content item to appear in an interactive map of a first user 102(1) in response to the social networking system 106 determining that the first user 102(1) follows the user account associated with the second user 102(2). Responsive to receiving content items from user accounts, the content item selection component 116 may determine that the content items are associated with the location.

At operation 118 (indicated by “3”), the content item selection component 116 selects content item from the multiple content items based on the location associated with the content item. In some examples, the content item selection component 116 may select the content item from the multiple content items based on popularity, where popularity may be based on the number of “likes” and/or a number of comments the feed post has received. Additionally or alternatively, the content item selection component 116 may select content items based on a recency of the post, where recency may be based on the time and/or date that the content item is shared by a user 102 on the social networking system 106.

In some examples, the map generation component 112 may receive more than one content item from the first user 102(1), where the additional content item(s) comprise indications of one or more different multi-author stories than the first multi-author story associated with the location. In some cases, the content item selection component 116 may receive content items from user accounts associated with the both the first multi-author story and any additional multi-author stories associated with the location. The content items selection component 116 may select a content item from the multiple content items based on the content item being associated with both the first multi-author story and the additional multi-author stories associated with the locations, along with factors described herein such as location relative to the device 104(1), popularity, recency, and the like. As an illustrative example, the first user 102(1) may enter a feed post comprising a digital picture of a burger or a milkshake associated with a location that serves both burgers and milkshakes. In response, the content item selection component 116 may populate the interactive map with feed posts associated with the location in the interactive map that include the digital picture of the burger or the milkshake. In this way, the user 102(1) may share the content item included on the interactive map with the interactive map displayed on computing devices 104(M) of users 102(N) that follow the user 102(1).

At operation 120 (indicated by “4”), the map generation component 112 generates an interactive map comprising a visual representation of the content item. In some examples, the interactive map may display the visual representation of the content item at a tagged location associated with the content item. For instance, if the content item is associated with a location at a coffee shop, the map generation component may display the visual representation of the content item on the interactive map at (or near) the location of the coffee shop on the interactive map. In some examples, the map generation component 112 may determine that an account of the first user 102(1) follows an account of the second user 102(2) on the social networking system 106. The map generation component 112 may populate the map with one or more visual representations of content item shared by the second user 102(2), allowing the first user 102(1) to view content items shared by accounts the first user 102(1) follows.

In some cases, a content item may include a common feature associated with a geolocation, alternatively or in addition to a tagged location of the content item. For example, a content item may additionally or alternatively include a location tag, but may include an indicator of a multi-author story such as “#Hawaii”. Responsive to determining that the feed post is associated with a multi-author story comprising a geolocation, the map generation component 112 may present the visual representation of the content item on the interactive map at or near that geolocation. A geolocation may include the name of a specific location, such as the name of a business, a restaurant, a park, or an attraction, to name a few examples. A geolocation may alternatively or additionally include the name of a specific geographic location, such as a neighborhood, a city, state, or country. As an illustrative example, the content item may be digital photograph tagged with the “#SeattleSpaceNeedle”. The map generation component 112 may present the visual representation of the content item on the interactive map at or near the Space Needle in Seattle.

In some cases, the map generation component 112 may include a portion of the geolocation on the interactive map, rather than an entirety of the geolocation. Responsive to determining the geolocation included in the content item, the map generation component 112 may display the geolocation on the map such that a portion of the total area of the geolocation is displayed (e.g., 10%, 20%, 30%, etc.). For example, the user 102(1) may include the tag “#Texas” in the content item in the operation 110. The map generation component 112 may display a portion of Texas on the interactive map, such as an area surrounding the capital of Texas, an area surrounding a location of the device 104(1) if the user 102(1) is located in Texas at the time of the search, and so forth.

At operation 122 (indicated by “5”), the map generation component 112 provides the interactive map comprising the visual representation of the content item to the account of the first user 102(1). For instance, providing the interactive map may include displaying the visual representation of the content item on the interactive map, where the first user 102(1) can access the content item. The interactive map may, in some examples, display a thumbnail of the content item, and/or an image or symbol representation associated with a multi-author story to give the first user 102(1) a preview of what is included in the content item and/or the multi-author story. Responsive to the first user 102(1) selecting the thumbnail of the feed post (e.g., via a touch input), the map generation component 112 may provide the content item shared by the second user 102(2) to be viewed by the first user 102(1).

In some examples, the interactive map may include multiple visual representations of content item associated with a multi-author story. In some cases, the multiple content items may be concentrated in one area, making individual content items difficult to view and/or select on the interactive map. For example, the first user 102(1) may zoom out of the interactive map such that multiple thumbnails representing the multiple content items are located in or around the same area. Thus, the interactive map may display a combined thumbnail which may include a number indicating a total number of content items located at or near the area. In response to the first user 102(1) selecting the combined thumbnail, the map generation component 112 may provide a list of the multiple content items. In some examples, the content items may include feed posts that may be displayed in the list in order of popularity and/or recency, similar to the description above.

Similar to the discussion above, the content item selection component 116 may select the content items to include on the interactive map based at least in part on a popularity of the individual content items and/or a recency of the individual content items. The map generation component 112 may populate the interactive map with the visual representations of the content items having the most likes within the threshold distance and within a threshold recency (e.g., the top 10% most popular feed posts within 2 miles of the computing device 104(1) and within the past 2 days), without filtering which content items to include based on multi-author stories included in the content items. In some cases, the map generation component 112 may limit the number of visual representations of content items displayed on the interactive map (e.g. 10 feed posts, 15 feed posts, 20 feed posts, etc.), thus providing the first user 102(1) with a manageable selection of content items to view.

In some examples, the map generation component 112 may generate a list of the content items associated with locations displayed on the interactive map and may provide the list to the user 102(1). The list may include an hours of operation, a category of services provided, and open or closed status, and/or an average price for goods and/or services provided by the location associated with each content items presented to the user 102(1).

In some examples, the social networking system 106 may provide privacy features to the users 102 while interacting with the social networking system 106. In particular examples, one or more objects (e.g., content items or other types of objects) of the computing system 100 may be associated with one or more privacy settings. The one or more objects may be stored on or otherwise associated with any suitable computing system or application, such as, for example, the social networking system 106, a client system, a third-party system, a social networking application, a messaging application, a photo-sharing application, or any other suitable computing system or application. Although the examples discussed herein are in the context of an online social network, these privacy settings may be applied to any other suitable computing system. Privacy settings (or “access settings”) for an object or content item may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” and/or a “restricted list” of users or other entities that should not be allowed to access certain information associated with the object. In particular examples, the blocked list may include third-party entities. The blocked list or restricted list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular examples, privacy settings may be based on one or more nodes or edges of a social graph. A privacy setting may be specified for one or more edges or edge-types of the social graph, or with respect to one or more nodes or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a user 102(1) may share a content item to the social networking system 106. The content item may be associated with a concept node connected to a user node of the user 102(1) by an edge. The user 102(1) may specify privacy settings that apply to a particular edge connecting to the concept node of the content item, or may specify privacy settings that apply to all edges connecting to the concept node. In some examples, the user 102(1) may share a set of content items of a particular object-type (e.g., a set of images). The user 102(1) may specify privacy settings with respect to all objects associated with the user 102(1) of that particular object-type as having a particular privacy setting (e.g., specifying that all images posted by the user 102(1) are visible only to friends of the user and/or users tagged in the images).

In particular examples, the social networking system 106 may present a “privacy wizard” (e.g., within a webpage, a module, one or more dialog boxes, or any other suitable interface) to the user 102(1) to assist the user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the social networking system 106 may offer a “dashboard” functionality to the user 102(1) that may display, to the user 102(1), current privacy settings of the user 102(1). The dashboard functionality may be displayed to the user 102(1) at any appropriate time (e.g., following an input from the user 102(1) summoning the dashboard functionality, following the occurrence of a particular event or trigger action). The dashboard functionality may allow the user 102(1) to modify one or more of the user's current privacy settings at any time, in any suitable manner (e.g., redirecting the user 102(1) to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, one or more servers of the social networking system 106 may be authorization/privacy servers for enforcing privacy settings. In response to a request from the user 102(1) (or other entity) for a particular object stored in a data store, the social networking system 106 may send a request to the data store for the object. The request may identify the user 102(1) associated with the request and the object may be sent only to the user 102(1) (or a client system of the user) if the authorization server determines that the user 102(1) is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular examples, an object may represent content that is visible to a user through a newsfeed of the user. As an example and not by way of limitation, one or more objects may be visible to a user's “Trending” page. In particular examples, an object may correspond to a particular user. The object may be content items associated with the particular user, or may be the particular user's account or information stored on the social networking system 106, or other computing system. As an example and not by way of limitation, the user 102(1) may view one or more other users 102(2) . . . 102(n) of an online social network through a “People You May Know” function of the online social network, or by viewing a list of friends of the user 102(1). As an example and not by way of limitation, the user 102(1) may specify that they do not wish to see objects associated with a particular other user (e.g., the user 102(2)) in their newsfeed or friends list. If the privacy settings for the object do not allow it to be surfaced to, discovered by, or visible to the user 102(1), the object may be excluded from the search results. Although this disclosure describes enforcing privacy settings in a particular manner, this disclosure contemplates enforcing privacy settings in any suitable manner.

In particular examples, different objects of the same type associated with a user may have different privacy settings. Different types of objects associated with a user may also have different types of privacy settings. As an example and not by way of limitation, the user 102(1) may specify that the user's status updates are public, but any images shared by the user are visible only to the user's friends on the online social network. In some examples, the user 102(1) may specify different privacy settings for different types of entities, such as individual users, friends-of-friends, followers, user groups, or corporate entities. In some examples, the user 102(1) may specify a group of users that may view videos posted by the user 102(1), while keeping the videos from being visible to the user's employer. In particular examples, different privacy settings may be provided for different user groups or user demographics. As an example and not by way of limitation, the user 102(1) may specify that other users who attend the same university as the user 102(1) may view the user's pictures, but that other users who are family members of the user 102(1) may not view those same pictures.

In particular examples, the social networking system 106 may provide one or more default privacy settings for each object of a particular object-type. A privacy setting for an object that is set to a default may be changed by a user associated with that object. As an example and not by way of limitation, all images posted by the user 102(1) may have a default privacy setting of being visible only to friends of the first user and, for a particular image, the user 102(1) may change the privacy setting for the image to be visible to friends and friends-of-friends.

In particular examples, privacy settings may allow the user 102(1) to specify (e.g., by opting out, by not opting in) whether the social networking system 106 may receive, collect, log, or store particular objects or information associated with the user 102(1) for any purpose. In particular examples, privacy settings may allow the user 102(1) to specify whether particular applications or processes may access, store, or use particular objects or information associated with the user. The privacy settings may allow the user 102(1) to opt in or opt out of having objects or information accessed, stored, or used by specific applications or processes. The social networking system 106 may access such information in order to provide a particular function or service to the user 102(1), without the social networking system 106 having access to that information for any other purposes. Before accessing, storing, or using such objects or information, the social networking system 106 may prompt the user 102(1) to provide privacy settings specifying which applications or processes, if any, may access, store, or use the object or information prior to allowing any such action. As an example and not by way of limitation, the user 102(1) may transmit a message to the user 102(2) via an application related to the online social network (e.g., a messaging app), and may specify privacy settings that such messages should not be stored by the social networking system 106.

In particular examples, the user 102(1) may specify whether particular types of objects or information associated with the user 102(1) may be accessed, stored, or used by the social networking system 106. As an example and not by way of limitation, the user 102(1) may specify that images sent by the user 102(1) through the social networking system 106 may not be stored by the social networking system 106. In some examples, the user 102(1) may specify that messages sent from the user 102(1) to another user 102(2) may not be stored by the social networking system 106. In some cases, the user 102(1) may specify that all objects sent via a particular application may be saved by the social networking system 106.

In particular examples, privacy settings may allow the user 102(1) to specify whether particular objects or information associated with the user 102(1) may be accessed from particular client systems or third-party systems. The privacy settings may allow the user 102(1) to opt in or opt out of having objects or information accessed from a particular device (e.g., the phone book on a user's smart phone), from a particular application (e.g., a messaging app), or from a particular system (e.g., an email server). The social networking system 106 may provide default privacy settings with respect to each device, system, or application, and/or the user 102(1) may be prompted to specify a particular privacy setting for each context. As an example and not by way of limitation, the user 102(1) may utilize a location-services feature of the social networking system 106 to provide recommendations for restaurants or other places in proximity to the user 102(1). The default privacy settings of the user 102(1) may specify that the social networking system 106 may use location information provided from the computing device 104(1) of the user 102(1) to provide the location-based services, but that the social networking system 106 may not store the location information of the user 102(1) or provide it to any third-party system. The user 102(1) may then update the privacy settings to allow location information to be used by a third-party image-sharing application in order to geo-tag photos.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example and not by way of limitation, a user may specify that a particular image uploaded by the user is visible to the user's friends for the next week, after which time the image may no longer be accessible to other users. In some examples, a company may post content related to a product release ahead of the official launch, and specify that the content may not be visible to other users until after the product launch.

In particular examples, for particular objects or information having privacy settings specifying that they are ephemeral, the social networking system 106 may be restricted in its access, storage, or use of the objects or information. The social networking system 106 may temporarily access, store, or use these particular objects or information in order to facilitate particular actions of a user associated with the objects or information, and may subsequently delete the objects or information, as specified by the respective privacy settings. As an example and not by way of limitation, the user 102(1) may transmit a message to the user 102(2), and the social networking system 106 may temporarily store the message in a data store until the user 102(2) has viewed or downloaded the message, at which point the social networking system 106 may delete the message from the data store. In some examples, continuing with the prior example, the message may be stored for a specified period of time (e.g., 2 weeks), after which point the social networking system 106 may delete the message from the data store.

In particular examples, changes to privacy settings may take effect retroactively, affecting the visibility of objects and content shared prior to the change. As an example and not by way of limitation, the user 102(1) may share a first image and specify that the first image is to be public to all other users. At a later time, the user 102(1) may specify that any images shared by the user 102(1) should be made visible only to a first user group. The social networking system 106 may determine that this privacy setting also applies to the first image and make the first image visible only to the first user group. In particular examples, the change in privacy settings may take effect only going forward. Continuing the example above, if the user 102(1) changes privacy settings and then shares a second image, the second image may be visible only to the first user group, but the first image may remain visible to all users. In particular examples, in response to a user action to change a privacy setting, the social networking system 106 may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the social networking system 106 may determine that user 102(1) may want to change one or more privacy settings in response to a trigger action associated with the user 102(1). The trigger action may be any suitable action on the online social network. As an example and not by way of limitation, a trigger action may be a change in the relationship between a first and second user of the online social network (e.g., “un-friending” a user, changing the relationship status between the users, etc.). In particular examples, upon determining that a trigger action has occurred, the social networking system 106 may prompt the user 102(1) to change the privacy settings regarding the visibility of objects associated with the user 102(1). The prompt may redirect the user 102(1) to a workflow process for editing privacy settings with respect to one or more entities associated with the trigger action. The privacy settings associated with the user 102(1) may be changed only in response to an explicit input from the user 102(1), and may not be changed without the approval of the user 102(1). As an example and not by way of limitation, the workflow process may include providing the user 102(1) with the current privacy settings with respect to the user 102(2) or to a group of users (e.g., un-tagging the user 102(1) or the user 102(2) from particular objects, changing the visibility of particular objects with respect to the user 102(2) or a group of users), and receiving an indication from the user 102(1) to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the social networking system 106 may determine that such action may be sensitive and may prompt the user to confirm that his or her relationship status should remain public before proceeding. In some examples, a user's privacy settings may specify that the user's posts are visible only to friends of the user. However, if the user changes the privacy setting for his or her posts to being public, the social networking system 106 may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the social networking system 106 may send a reminder to the user to confirm his or her privacy settings every six months or after every ten photo posts. In particular examples, privacy settings may also allow users to control access to the objects or information on a per-request basis. As an example and not by way of limitation, the social networking system 106 may notify the user whenever a third-party system attempts to access information associated with the user, and require the user to provide verification that access should be allowed before proceeding.

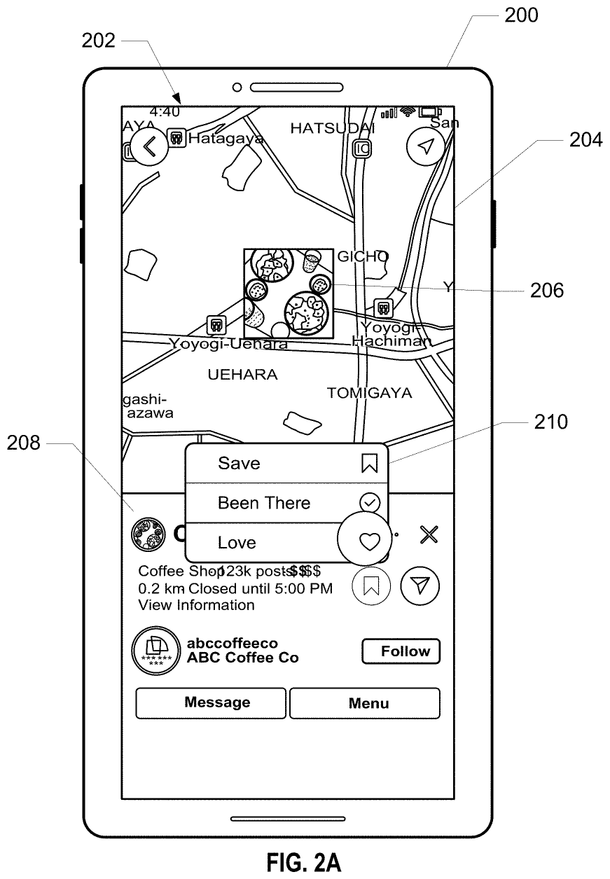

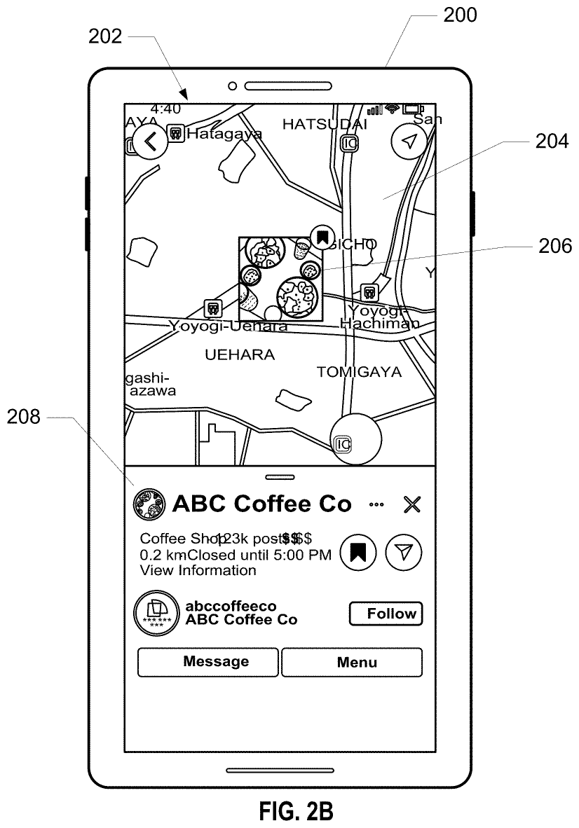

FIGS. 2A and 2B illustrates an example device 200 including a user interface 202. The user interface 202 may include an interactive map 204. The device 200 may receive a content item 206 from a user that is associated with a location and a visual representation (e.g., a thumbnail, icon, symbol, etc.) associated with the content item may be presented on the interactive map 204. The user interface 202 may also include an informational section 208 that provides a description and/or details of the location associated with the content item. The informational section 208 may be displayed in, on, or in association with (e.g., overlaid on, presented adjacent to, etc.) the user interface 202 in response to a selection of the location on the interactive map 204. The informational section 208 may include information such as a name of the establishment at the location, a distance from the example device 200 to the establishment, types of goods and/or services offered at the establishment, a price of goods and/or services offered by the establishment, whether the establishment is open or closed, and the like. For example, the content item 206 may include a feed post that is associated with a location, ABC Coffee Co. The feed post may include a digital photograph created by a digital camera included in the device 200. Upon receiving the feed post, the device may provide the user with a control 210 that allows the user to select one or more multiple different types of feedback. The multiple different types of feedback include “Save”, “Been There”, and “Love” and the control 210 may include multiple distinct portions or sub-controls, each distinct portion or sub-control being usable to provide a respective one of the different types of feedback. The “Save” option allows the user to save the location to a collection of saved locations associated with the user. For example, the user may select this option if the user plans to go to the saved location in the future, wishes to save the location as a wish list of future destinations, or plans to create a guide or collection of locations to be shared with other users. The “Been There” option allows the user to check-in at the location and to indicate that the user has been to (or is currently at) the location. The “Love” option allows the user to recommend the location to other users that may follow the user. After selecting at least one of multiple different types of feedback using the control 210, the interactive map may present a visual indication of the selected type of feedback. In this way, the social networking system may simplify the number of inputs necessary to provide the multiple different types of feedback since the social networking system presents the user with three options (e.g., Save, Been There, and Love). While the terms “Save,” “Been There,” and “Love” are used to designate three different distinct types of feedback, in other examples, other labels or terms can be used and associated with the different types of feedback (e.g., “like,” “celebrate,” “thumbs up,” or any other suitable designator of a particular type of feedback).

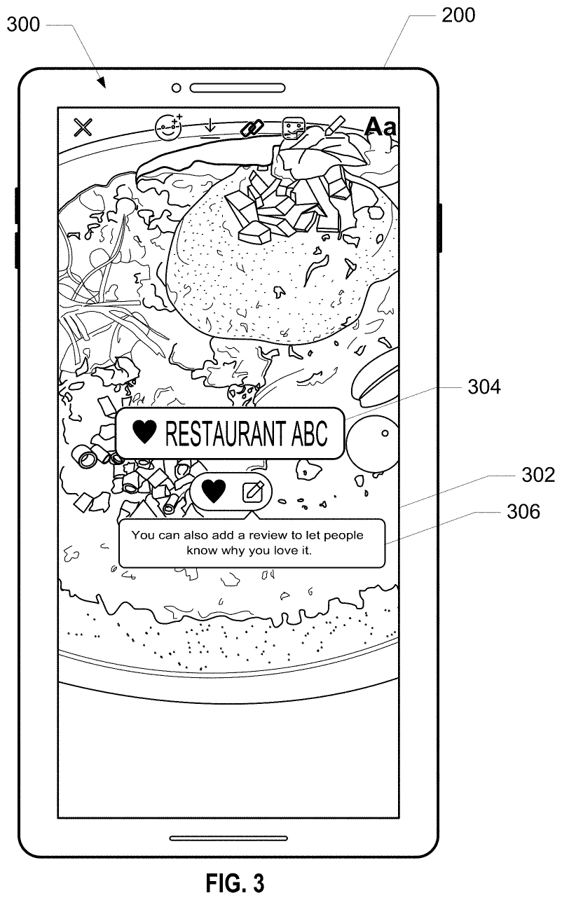

FIG. 3 illustrates the example device 200 including a user interface 300 associated with a user creating a content item 302 at a location. The user interface 300 may include a content item 302, such as story, reel, or feed post. The content item 302 may be associated with a location (e.g., Restaurant ABC). In some examples, the social networking system may automatically recognize creation of the content item 302 at or near the location as a particular type of feedback associated with the location from among the multiple types of feedback. For instance, the social networking system, determine that location data associated with the user's computing device indicates that the computing device is within a threshold distance of the location. In that case, the social networking system may treat the creation of the content item 302 at the location as an indication of a particular type of feedback (e.g., the “Love” type of feedback), and may associate the particular type of feedback provided by the user with the location. In some examples, the interface 300 and/or the content item 302 may include a visual representation 304 indicating the particular type of feedback (e.g., a heart in this example to indicate the “Love” type of feedback) inferred based at least in part on the user creating the content item 302 at the location.

In some examples, based at least in part on receiving the content created at or near the location, the social networking system may automatically cause a prompt 306 to be presented to the user to recommend the location. In some examples, the prompt 306 may be presented proximate to or in association with the visual representation 304 of the particular type of feedback. In this case, the user may be automatically prompted to recommend Restaurant ABC if the user is at or nearby Restaurant ABC when the story 302 associated with Restaurant ABC is created. In the illustrated example, the prompt is presented as carrot or dialog bubble protruding from a graphical element (e.g., pill shaped region) comprising the visual representation 304 of the particular type of feedback. However, in other examples, the visual representation 304 of the particular type of feedback and/or the prompt 306 may be presented in different configurations (e.g., shapes, positions, orientations, and/or spacings relative to one another). Depending at least in part on the privacy settings of the user, other users of the social networking system may be presented with an interactive map that includes the content items and/or the selected feedback of the user.

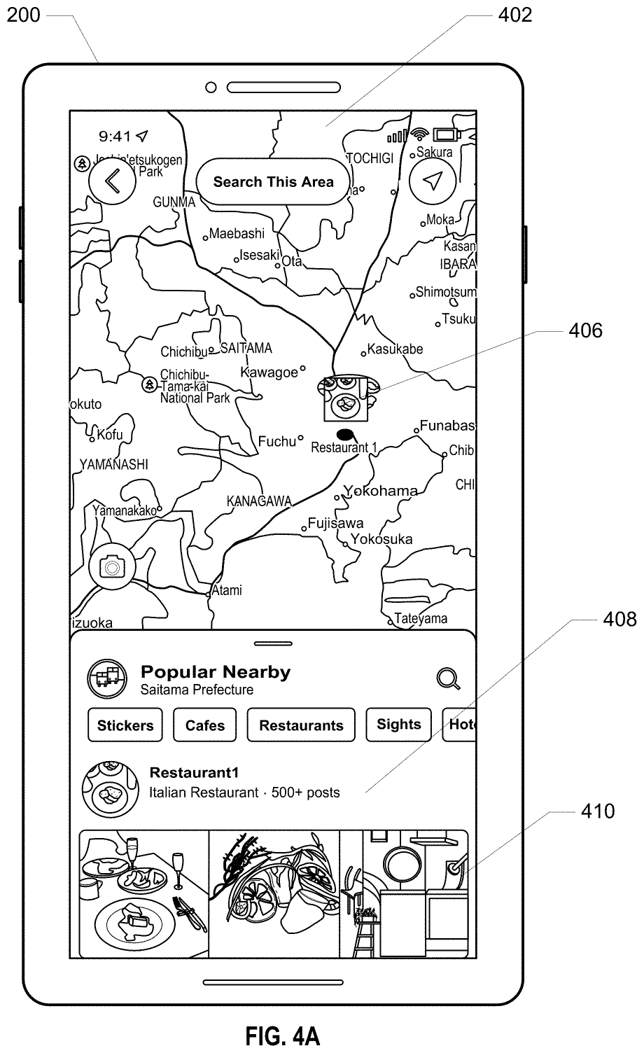

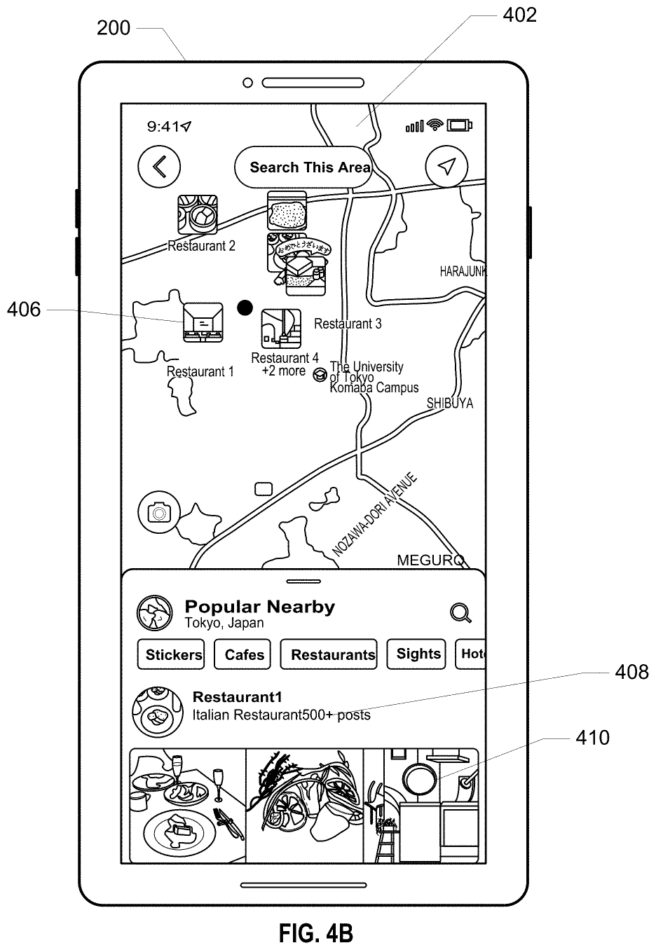

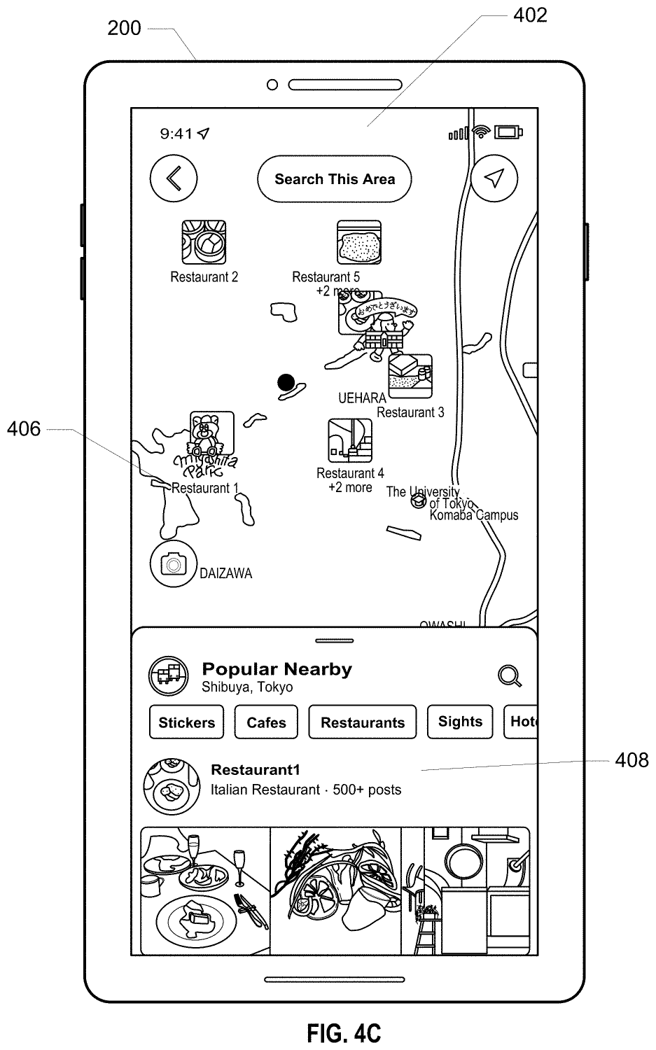

FIGS. 4A-4C illustrate the example device 200 including a user interface 400. The user interface may include an interactive map 402 that displays a geographic region. For example, the interactive map 402 may display a geographic region associated with Saitama Prefecture. At this zoom level, a first defined geographic region may include Saitama Prefecture. The first defined geographic region may include a content item 406 that exist within Saitama Prefecture. For example, the content item 406 may include a feed post associated with a location Restaurant1 that is within first defined geographic region. The user interface also includes a tab 408 that may provide details of the location Restaurant1 that is associated with the content item 406. The user may adjust the interactive map 402 to zoom in to a level that displays a second defined geographic region that includes the first defined geographic region. At this zoom level, additional establishments associated with the second defined geographic region are displayed. For example, when the user zooms in to Tokyo, Japan, the interactive map 402 is updated to include content items associated with Restaurant1, Restaurant2, Restaurant3, and Restaurant4 that exist within the second defined geographic region. The user may adjust the interactive map 402 and zoom in to a level that displays a third defined geographic region that is included in the first and second defined geographic regions. At this zoom level, additional establishments associated with the third defined geographic region are displayed. For example, when the user zooms in to Shibuya, Tokyo, the interactive map 402 is updated to include content items associated with Restaurant1, Restaurant2, Restaurant3, Restaurant4, and additionally Restaurant5.

At each zoom level, tab 408 is updated to correspond with the defined geographic region displayed by the interactive map 402. For example, at the highest zoom level, the tab is updated to correspond to Saitama Prefecture, the second highest level zoom is updated to correspond to Tokyo, Japan, the lowest zoom level is updated to correspond to Shibuya, Tokyo. In some examples, the tab 408 may be presented in response to a selection of a content item 406 associated with an establishment included in the region displayed by the interactive map 402. The tab 408 may include additional content items associated with the establishment. The additional content items may include images 410 that have been shared on the social networking system by different users than. Depending at least in part on the security preferences of the user, the user may view content items shared by user that may or may not follow the user on the social networking system. In this case, the user may obtain more information about the selected establishment.

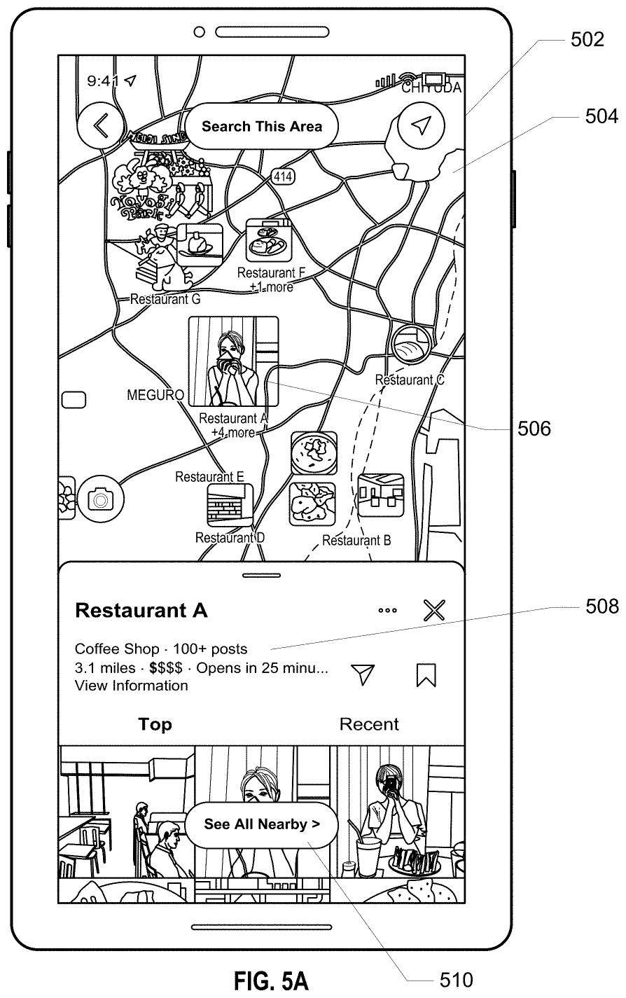

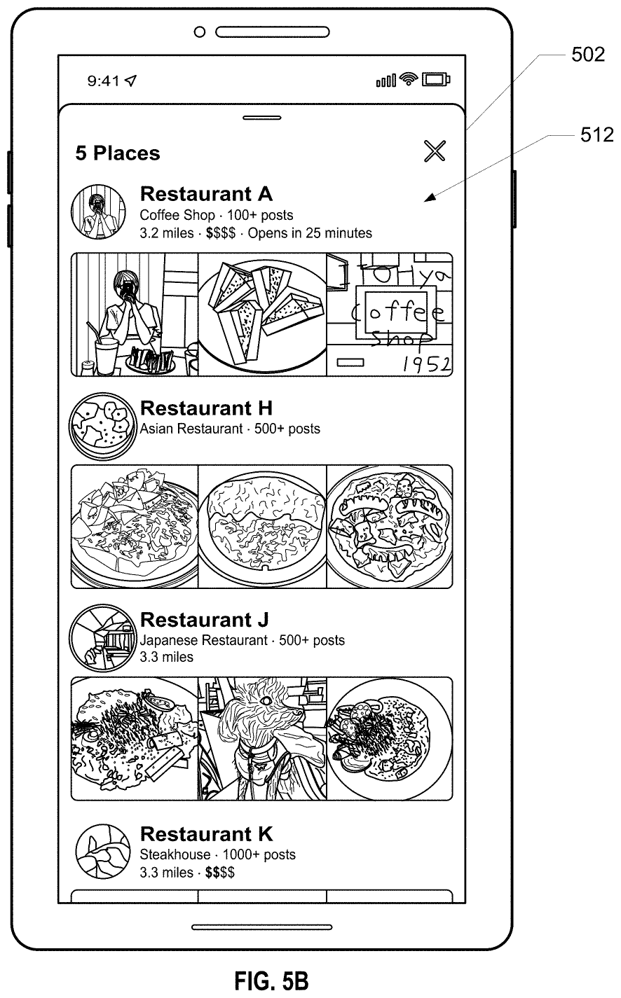

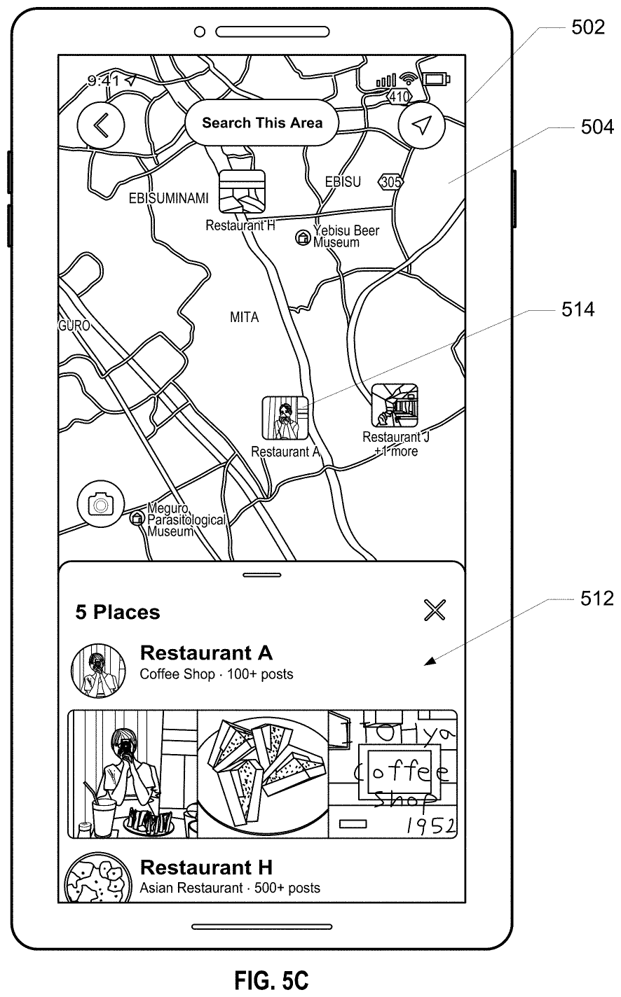

FIGS. 5A-5C illustrate the example device 200 including a user interface 502. Similar to FIG. 2A, the user interface 502 includes an informational section 508 and interactive map 504. At this zoom level, the interactive map 504 may display a geographic region that includes a content item that is associated with multiple content items that are associated with the same location. For example, content item 506 is associated with RestaurantA and 4 more additional content items that are associated with respective establishments at the same location. The selection of RestaurantA as the main label of the content item 506 is based at least in part on a popularity of the individual content items and/or a recency of the individual content items. To access the additional four content items, the user may select the content item 506. In response, the user interface presents the informational section 508 that displays information associated with the RestaurantA. The informational section tab 508 may include an icon 510 (e.g., pill icon “See All Nearby”) that allows the user to access the four additional content items associated with their respective establishments. In response to the user selecting the icon “See All Nearby”, the user interface 502 is updated to display a list 512 of the four additional establishments associated with the location. For example, the list 512 may include information on RestaurantH, RestaurantJ, and RestaurantK. The user may select one of the listed establishments. In response, the user interface 502 may be updated to display the interactive map 504 zoomed in to level such that a visual representation 514 of the content item associated with the selected establishment is tagged to its own location on the interactive map 504 and the list 512 is minimized or reduced in size to accommodate the interactive map 504.

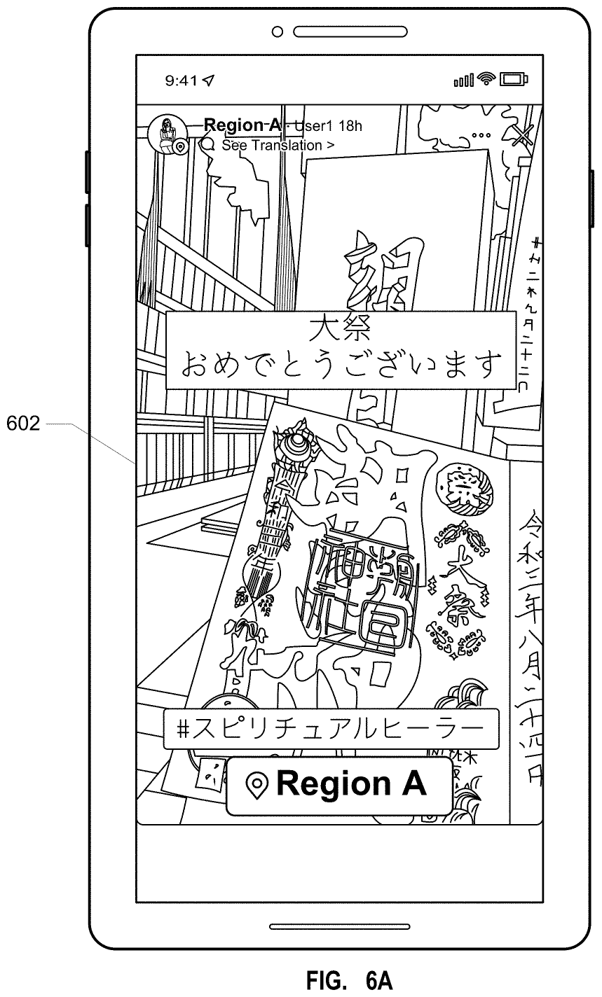

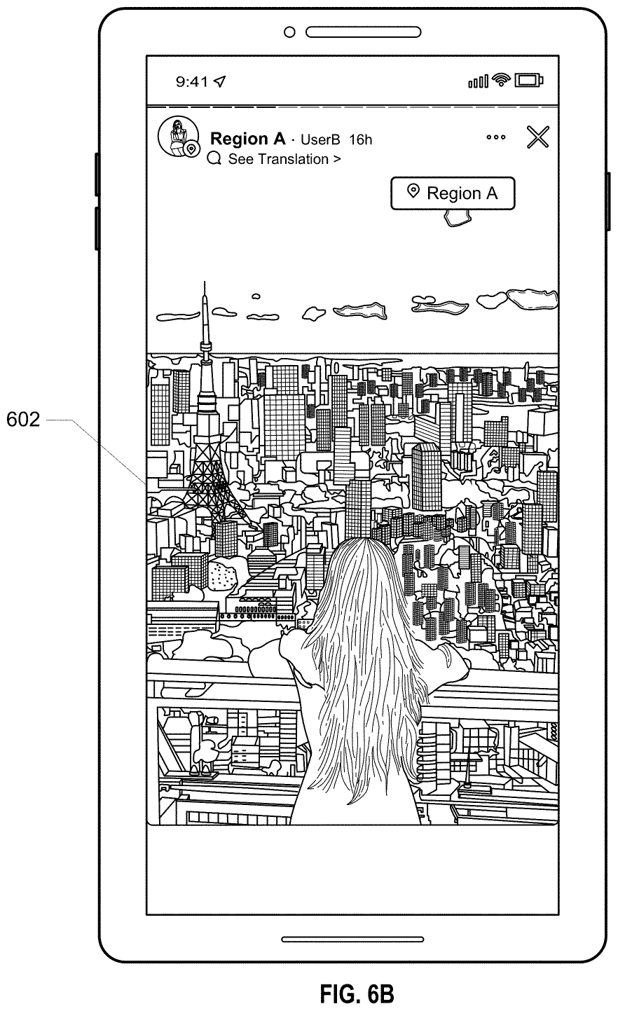

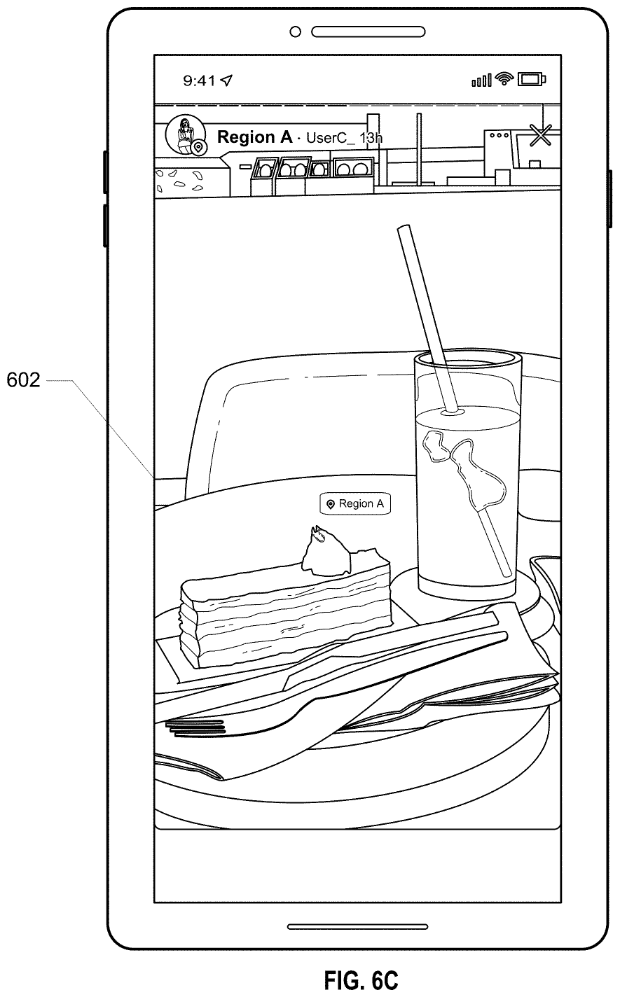

FIGS. 6A-6C illustrate the example device 200 including a user interface 602. Similar to FIG. 3, where users may create a content item 306 (e.g., story) that is associated with a location such as Restaurant ABC, users may create content items that are associated with a region, such as a neighborhood, a city, a county, a state, a prefecture, a country, or the like. Content items may include a feed post, a reel, a story, or other type content items (e.g., images, audio, video, stickers, etc.). In some cases, a user's story that is associated with a region may be included in a multi-author story associated with the region that is created by other users. For example, FIGS. 6A-6C illustrate a multi-author story associated with Region A. Each story of the multi-author story is authored by a different user, UserA, UserB, and UserC, respectively. The multi-author story useful in helping a user determine the look and feel of the region. A user may decide to visit the region based at least in part on the multi-author story associated with the region. In some examples, the first story of the multi-author story and the second story of the multi-author story are displayed based on a popularity of the individual stories relative to one another and/or a recency that the individual stories are shared. Popularity, for example, may be based on a number of “likes” and/or comments the story has, where the multiple stories of the multi-author story may be displayed in order of descending number of “likes” and/or comments. Additionally or alternatively, recency may be based on a time that the story was shared, where the most recent stories may be displayed first.

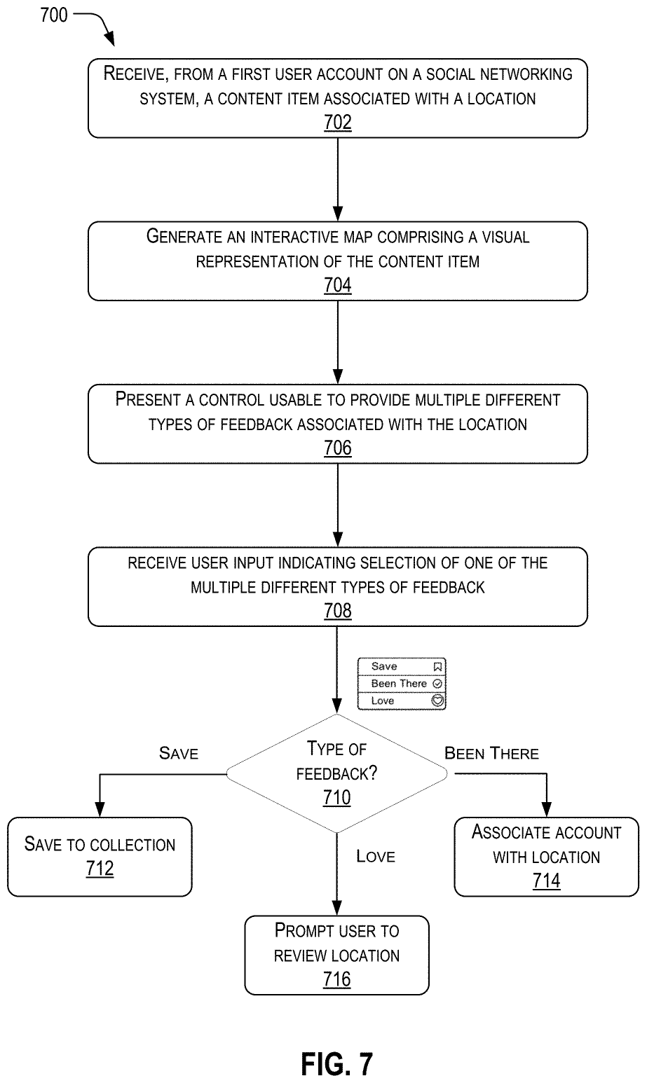

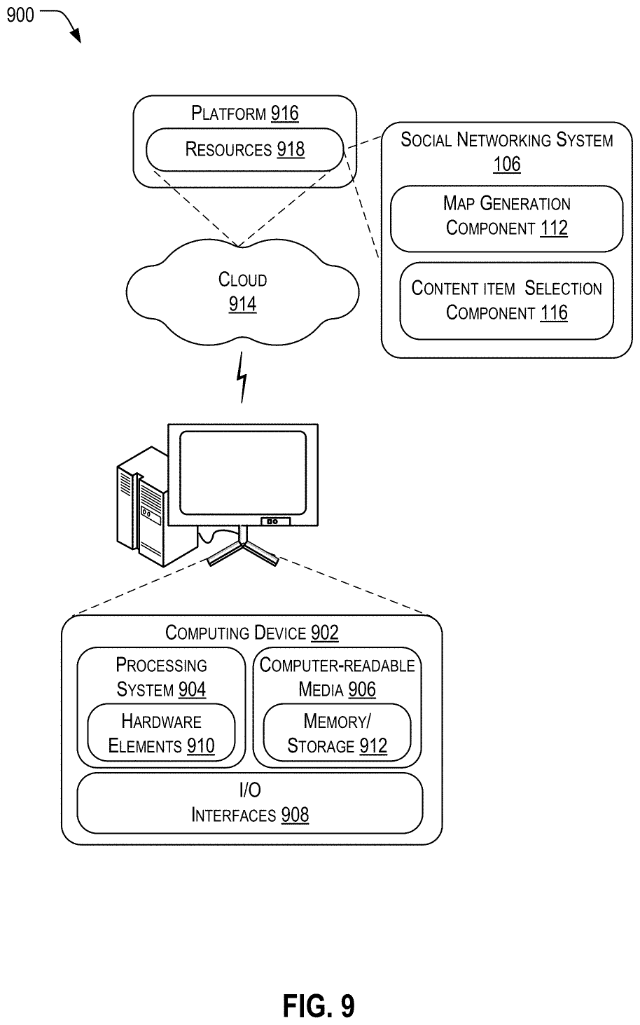

FIG. 7 illustrates an example process 700 for generating a social networking map using the techniques described herein. The example process 700 is described with reference to the example system of FIG. 1 and/or the user interfaces of FIGS. 2A-6C for convenience and ease of understanding. However, the example process 700 is not limited to being performed using the systems of FIG. 1 and/or FIG. 9, and/or the user interfaces of FIGS. 2A-6C and may be implemented using systems and devices other than those described herein.

The process 700 described herein represents a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process. In some examples, one or more operations of the process 700 may be omitted entirely. Moreover, the process 700 described herein can be combined in whole or in part with other methods.

The method 700 includes an operation 702 of receiving, from a first user account of a social networking system, a content item associated with a location. In some examples, the content item may include a feed post, a story, a video reel, etc. In some examples, the content item can be persistent (e.g., non-ephemeral) and, once shared by the first user account, can populate feeds of user accounts that follow the first user account on the social networking system. In some examples, the content item can be ephemeral and, once shared by the first user account, can populate a story field of user accounts that follow the first user account on the social networking system.

An operation 704 includes generating an interactive map of a geographic region or area, the interactive map comprising a visual representation of the content item. In some examples, the interactive map may display the visual representation of the content item at a location associated with the content item (e.g., a location at which the content item was created/generated, a location depicted or referenced in the content item, etc.). In some cases, the interactive map may populate the map with a content item that is shared by a second user account which the first user account follows on the social networking system. The content item may, in some examples, include a common feature associated with a geolocation, where the geolocation may include the name of a specific location. The interactive map may display the entirety of the geolocation or a portion of the geolocation, in some examples. Additionally or alternatively, the interactive map may display content items that are within a threshold distance of the first user and/or are within a region of the interactive map that is currently being displayed.

An operation 706 includes presenting a control usable to provide multiple different types of feedback associated with the location. In some cases, the multiple different types of feedback may include saving the location to a collection of saved locations, checking-in at the location indicating that the user has physically been to the location, and recommending the location to other users of the social networking system. In some cases, the interactive map may provide a visual indication to the interactive map of a second user that follows the first user that the first user has saved the location to a collection of saved locations associated with the first user, a visual indication that the first user has been to the location, and/or a visual indication that the first user recommends the location. In some cases, the interactive map may be updated to include visual representation of a multi-author story that is associated with the location. The visual representation can be illustrated by a thumbnail of a feed post, reel, or a story of the multi-author story. This allows the user to access content items associated with the location that is provided by the users of the social networking system.

An operation 708 includes receiving user input that includes a selection of a particular type of feedback from among the multiple different types of feedback. The multiple different types of feedback include “Save”, “Been There”, and “Love”. At operation 710, the social networking system may determine the type of feedback received, from among the multiple different types of feedback. In some examples, a control (e.g., control 210) of the social networking system may provide portions to enable the user to provide the various different types of feedback. If at operation 710 the system determines that the user input comprise the “Save” option, the system may at operation 712 save the location to a collection of saved locations associated with the user. For example, the user may select this option if the user plans to go to the saved location in the future, wants to save the location as a wish list of future destinations, or plans to create a guide or collection of locations to be shared with other users. If at operation 710 the system determines the user input to be the “Been There” option, at operation 714 the system may cause the user to be checked-in at the location to indicate that the user has been to (or is currently at) the location and to cause the system to associate the user account with the location. If at operation 710 the system determines the user input to be the “Love” option, the system may at operation 716 share the location with one or more followers of the user, recommend the location to other users that may follow the user, and/or prompt the user account to review the location. In this way, the social networking system may simplify the number of inputs necessary to provide the multiple different types of feedback since the social networking system presents the user with three options (e.g., Save, Been There, and Love). The system may thereby reduce the processing burden on the system and on the user's computing device, consequently reducing energy consumption of the social networking system computing devices and/or the user's computing device.

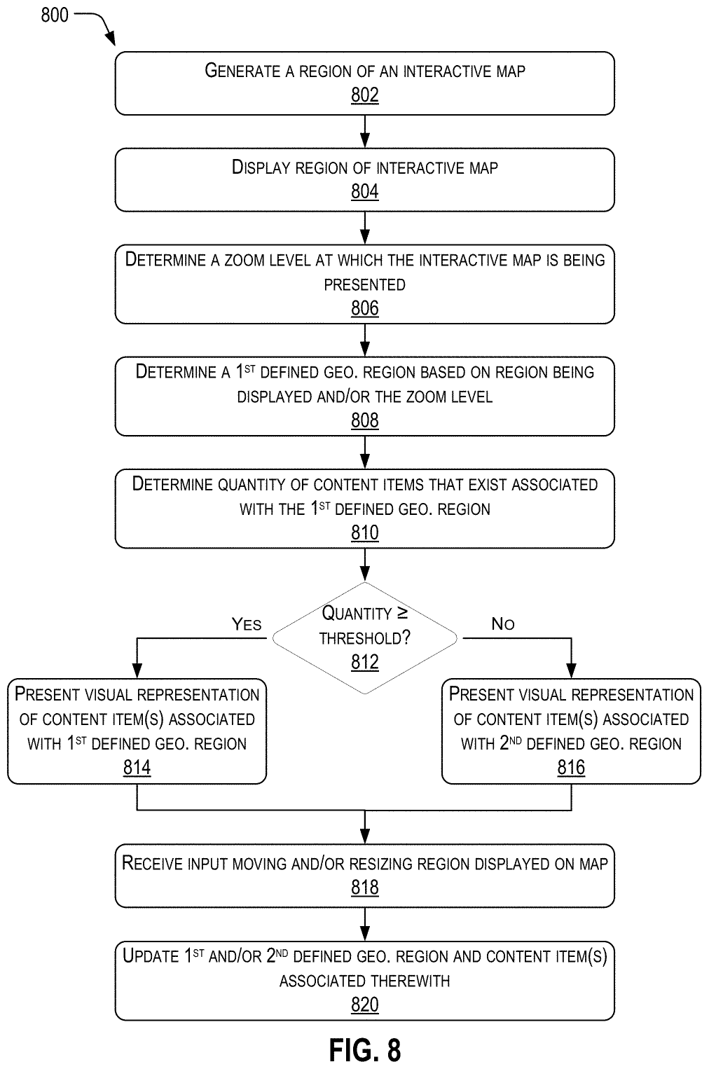

FIG. 8 illustrates an example process 800 for generating a social networking interactive map using the techniques described herein to present representations of content items on the interactive map based at least in part on a zoom level of the map and/or number of content items associated with a region displayed on the map at the zoom level. The example process 800 is described with reference to the example system of FIG. 1 and/or the user interfaces of FIGS. 2A-6C for convenience and ease of understanding. However, the example process 800 is not limited to being performed using the systems of FIG. 1 and/or FIG. 9, and/or the user interfaces of FIGS. 2A-6C and may be implemented using systems and devices other than those described herein.

The process 800 includes, at operation 802, generating a region of an interactive map. In some examples, the region may include a geographic region, such as a neighborhood, a city, a prefecture, a state, and a country. An operation 804 includes displaying the generated region on an interactive map. In some examples, the displayed region may include the location of the device of the user accessing the interactive map and/or a region proximate the location of the device of the user. In some examples, the displayed region may include a location specified in or associated with a search query (e.g., an address, hashtag, coordinates, or other search term).

An operation 806 includes determining a zoom level at which the interactive map is being presented. The zoom level is associated with a scale on the interactive map that corresponds to a geographic region. In some examples, the geographic region may include a neighborhood, a city, a county, a prefecture, a state, or a country.

An operation 808 includes determining a first defined geographic region that is based on at least in part on the region being displayed on the interactive map and/or the zoom level of the interactive map. In some cases, the displayed first defined geographic region may correspond to a state, prefecture, county, city, or neighborhood.

An operation 810 includes determining and presenting a quantity of content items that exist associated with the defined geographic region displayed in the interactive map. In some examples, the interactive map is provided with visual representations of one or more content items (e.g., feed posts, reels, stories, etc.), that are associated with locations in the first defined geographic region. In some examples, the system may determine, at operation 812, if the quantity of content items may meet a threshold number of content items. If it is determined at operation 812 that the quantity of content items is greater than or equal to the threshold number of content items, the interactive map may be provided at operation 814 with visual representations of one or more content items that are associated with the first defined geographic region. If it is determined at operation 812 that the quantity of content items is less than the threshold number of content items, the interactive map may at operation 816 be provided with visual representations of one or more content items that are associated with a second defined geographic region different than the first geographic region. In some cases, the second defined geographic region may be adjacent to the first defined geographic region or may encompass the first defined geographic region. For example, content items of the second defined geographic region may be associated with a neighborhood that is adjacent to the first defined geographic region. In another example, content items of the second defined geographic region may be associated with a county or city that encompasses the first defined geographic region. In some examples, if it is determined at operation 812 that the quantity of content items is less than the threshold number of content items, the interactive map may at operation 816 be provided with visual representations of one or more content items that are associated with both the first defined geographic region and the second defined geographic region. In any of these ways, the social networking system may provide at least the threshold quantity of content items on an interactive map to a user even if the quantity of content items associated with the first defined geographic region is sparse (e.g., below the threshold).

Furthermore, the social networking system may display a list of content items associated with either the first defined geographic region or the second defined geographic region. In some examples, the interactive map may also include a tab that may provide details associated with the feed post. For example, the tab may include information such as a name of the establishment tagged in the feed post, the distance from the device associated with the first user account to the location tagged in the feed post, types of goods/services offered at the establishment, and whether the establishment is open or closed, to name a few examples. In some examples, the tab may provide the user a selectable option to order goods or services from the establishment. Additionally or alternatively, the tab may include a selectable image from the feed post shared by a user. Upon selection of the image, the user may be presented with the original feed post that was used to populate the map, including comments by other users of the social networking system 106 and controls that, when selected, enable the user to like the feed post, comment on the feed post, save and/or bookmark the feed post, and the like. In this way, the user may explore the location associated with the feed post before, for example, visiting or ordering from the location.

An operation 818 includes receiving input from the user moving and/or resizing—by altering the zoom level—the geographic region displayed on the interactive map. Upon receiving the input, the social networking system may, at operation 820, update the first defined geographic region and/or the second defined geographic region, and their corresponding content items displayed on the interactive map. In some examples, the system may present an updated list of content items that are associated with the updated defined geographic region.

### Example System and Device

FIG. 9 illustrates an example system generally at 900 that includes an example computing device 902 that is representative of one or more computing systems and/or devices that may implement the various techniques described herein. This is illustrated through inclusion of the map generation component 112 and the content item selection component 116. The computing device 902 may be, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 906 is illustrated as including memory/storage component 912. The memory/storage component 912 represents memory/storage capacity associated with one or more computer-readable media. The memory/storage component 912 may include volatile media (such as random access memory (RAM)) and/or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “logic,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on and/or transmitted across some form of computer-readable media. The computer-readable media may include a variety of media that may be accessed by the computing device 902. By way of example, and not limitation, computer-readable media may include “computer-readable storage media” and “computer-readable transmission media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable transmission media” may refer to a medium that is configured to transmit instructions to the hardware of the computing device 902, such as via a network. Computer-readable transmission media typically may transmit computer-readable instructions, data structures, program modules, or other data in a modulated data signal, such as carrier waves, data signals, or other transport mechanism. Computer-readable transmission media also include any information delivery media. The term “modulated data signal” means a signal that has one or more of its characteristics set or changed in such a manner as to encode information in the signal. By way of example, and not limitation, computer-readable transmission media include wired media such as a wired network or direct-wired connection, and wireless media such as acoustic, radio frequency (RF), infrared, and other wireless media.

As previously described, hardware elements 910 and computer-readable media 906 are representative of modules, programmable device logic and/or device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

The techniques described herein may be supported by various configurations of the computing device 902 and are not limited to the specific examples of the techniques described herein. This functionality may also be implemented all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 may include applications and/or data that can be utilized while computer processing is executed on servers that are remote from the computing device 902. Resources 918 can also include services provided over the Internet and/or through a subscriber network, such as a cellular or Wi-Fi network.

The platform 916 may abstract resources and functions to connect the computing device 902 with other computing devices. The platform 916 may also be scalable to provide a corresponding level of scale to encountered demand for the resources 918 that are implemented via the platform 916. Accordingly, in an interconnected device embodiment, implementation of functionality described herein may be distributed throughout multiple devices of the system 900. For example, the functionality may be implemented in part on the computing device 902 as well as via the platform 916 which may represent a computing environment or cloud 914.

The example systems and methods of the present disclosure overcome various deficiencies of known prior art devices. Other embodiments of the present disclosure will be apparent to those skilled in the art from consideration of the specification and practice of the disclosure contained herein. It is intended that the specification and examples be considered as example only, with a true scope and spirit of the present disclosure being indicated by the following claims.

### CONCLUSION

Although the discussion above sets forth example implementations of the described techniques, other architectures may be used to implement the described functionality, and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
generating a region of an interactive map;
displaying the region of the interactive map;
determining a zoom level at which the interactive map is being displayed;
determining a first defined geographic region based at least in part on the region being displayed and the zoom level at which the interactive map is being displayed;
determining a quantity of content items that exist that are associated with the first defined geographic region; and
presenting, based at least in part on the quantity, a visual representation on the interactive map of one or more content items associated with at least one of the first defined geographic region or a second defined geographic region that encompasses the first defined geographic region.

2. The method of claim 1, the method further comprising:
determining whether the quantity of content items associated with the first defined geographic area is below a threshold,
wherein the presenting comprises presenting one or more content items associated with the second defined geographic region when the quantity of content of items is below the threshold.

3. The method of claim 1, the method further comprising, determining, based at least in part on the quantity of content items, whether to present visual representations associated with the first defined geographic region or the second defined geographic region.

4. The method of claim 1, the method further comprising, displaying a list of one or more content items associated with at least one of the first defined geographic region or the second defined geographic region.

5. The method of claim 4, the method further comprising:
receiving input moving or resizing the region displayed on the interactive map; and
updating the first defined geographic region and the list of one or more content items associated therewith.

6. The method of claim 1, the method further comprising, displaying a guide that includes one or more content items associated with a location associated with at least one of the first defined geographic region or the second defined geographic region.

7. The method of claim 1, wherein the visual representation on the interactive map comprises a multi-author story comprising a first content item authored by a first user account and a second content item authored by a second user account, and wherein the first content item and the second content item are associated with at least one of the first defined geographic region or the second defined geographic region.

8. The method of claim 1, the method further comprises:
presenting a visual representation associated with a first content item associated with a location in the defined region of the interactive map, the visual representation further representing at least a second content item associated with the location;
displaying a list of details and at least one content item associated with only the first content item; and
displaying an icon configured to access at least the second content item.

9. One or more computer-readable media storing instructions that, when executed by one or more processors, configure a device to perform operations comprising:
generating a region of an interactive map;
displaying the region of the interactive map;
determining a zoom level at which the interactive map is being displayed;
determining a first defined geographic region based at least in part on the region being displayed and the zoom level at which the interactive map is being displayed;
determining a quantity of content items that exist that are associated with the first defined geographic area; and
presenting, based at least in part on the quantity, a visual representation on the interactive map of one or more content items associated with at least one of the first defined geographic region or a second defined geographic region that encompasses the first defined geographic region.

10. The one or more computer-readable media of claim 9, the operations further comprising:
determining whether the quantity of content items associated with the first defined geographic area is below a threshold,
wherein the presenting comprises presenting one or more content items associated with the second defined geographic region when the quantity of content of items is below the threshold.

11. The one or more computer-readable media of claim 9, the operations further comprising, determining, based at least in part on the quantity of content items, whether to present visual representations associated with the first defined geographic region or the second defined geographic region.

12. The one or more computer-readable media of claim 9, the operations further comprising, displaying a list of one or more content items associated with at least one of the first defined geographic region or the second defined geographic region.

13. The one or more computer-readable media of claim 12, the operations further comprising:
receiving input moving or resizing the defined geographic region displayed on the interactive map; and
updating the defined geographic region and the list of one or more content items associated therewith.

14. The one or more computer-readable media of claim 9, the operations further comprising, displaying a guide that includes one or more content items associated with a location associated with at least one of the first defined geographic region or the second defined geographic region.

15. The one or more computer-readable media of claim 9, wherein the visual representation on the interactive map comprises a multi-author story comprising a first content item authored by a first user account and a second content item authored by a second user account, and wherein the first content item and the second content item are associated with at least one of the first defined geographic region or the second defined geographic region.

16. The one or more computer-readable media of claim 9, the operations further comprising:
presenting a visual representation associated with a first content item associated with a location in the defined region of the interactive map, the visual representation further representing at least a second content item associated with the location;
displaying a list of details and at least one content item associated with only the first content item; and
displaying an icon configured to access at least the second content item.

17. A system comprising:
one or more processors; and
one or more computer readable media storing instructions that, when executed by the one or more processors, configure the system to perform operations comprising:
generating a region of an interactive map;
displaying the region of the interactive map;
determining a zoom level at which the interactive map is being displayed;
determining a first defined geographic region based at least in part on the region being displayed and the zoom level at which the interactive map is being displayed;
determining a quantity of content items that exist that are associated with the first defined geographic area; and
presenting, based at least in part on the quantity, a visual representation on the interactive map of one or more content items associated with at least one of the first defined geographic region or a second defined geographic region that encompasses the first defined geographic region.

18. The system of claim 17, the operations further comprising:
determining whether the quantity of content items associated with the first defined geographic area is below a threshold,
wherein the presenting comprises presenting one or more content items associated with the second defined geographic region when the quantity of content of items is below the threshold.

19. The system of claim 17, the operations further comprising, determining, based at least in part on the quantity of content items, whether to present visual representations associated with the first define geographic region or the second defined geographic region.

20. The system of claim 17, the operations further comprising:
displaying a list of one or more content items associated with at least one of the first defined geographic region or the second defined geographic region;
receiving input moving or resizing the defined geographic region displayed on the interactive map; and
updating the defined geographic region and the list of one or more content items associated therewith.
